(19) United States
(12) Patent Application Publication
(10) Pub. No.: US 2006/0115548 A1
(43) Pub. Date: Jun. 1, 2006

(54) Simultaneous longitudinal and transverse film drawing device

(76) Inventors: Innocente Marchante Moreno, Le Bourget du Lac (FR); Glbert Trivero, La Chavanne (FR)

Correspondence Address: OLIFF & BERRIDGE, PLC, P.O. BOX 19928, ALEXANDRIA, VA, 22320, US

(21) Appl. No.: 10/538,337

(22) PCT Filed: Dec. 24, 2003
(86) PCT No.: PCT/FR03/03901

§ 371 Date: Sep. 14, 2005

(30) Foreign Application Priority Data
Jan. 15, 2003 (FR) 03/00400

(51) Int. Cl. B29C 55/16

(52) U.S. Cl. 425/66

(57) ABSTRACT

The invention relates to a mechanical device which is used for the simultaneous longitudinal and transverse drawing of synthetic films, using successive clamps (13) for supporting, transporting and drawing said film (2). According to the invention, an endless chain (8) is provided on each side of the film, said chain comprising a succession of links (9, 10) which are articulated to one another using vertical shafts (11, 12). The aforementioned clamps (13), which are connected to one shaft (11) out of two, extend out over one side of the chain (8) and are guided on a first rail (14). The invention also comprises guide pieces (15) which are also connected to one shaft (12) out of two, between the clamps (13), and which move on a second rail (16). A variable spacing (E, e) is disposed between the two rails (14, 16), such that the links (9, 10) are essentially aligned or form angles so as to fix or modify the distance (d, D) between the clamps (13).

The present invention relates to a mechanical device for simultaneously drawing plastic films in the longitudinal direction and in the transverse direction, also known more simply as a “simultaneous film drawing device”.

Films of biaxially oriented plastic are obtained from an extruded strip, after material in the melt state has been deposited on a casting drum that is cooled so as to slow the crystallization of the film and allow it to be drawn subsequently.

The strip then passes into a longitudinal drawing machine in which drawing is performed on the principle of a difference in speed between various successive rolls. The strip then passes into a transverse drawing machine, in which the strip is held by grippers mounted on chains, the separation of which progressively increases.

This type of drawing, known as sequential drawing, is perfectly suitable for numerous plastics such as polypropylene, polyester, and is therefore widely used in industry.

By contrast, other types of film, such as those made of polyamide and of polyethylene, are characterized by the fact that, in order to obtain the characteristics required by their subsequent use, drawing in the longitudinal direction and drawing in the transverse direction need to take place simultaneously rather than, as indicated hereinabove, sequentially.

One well-known reason that dictates this simultaneous drawing is that certain products have a tendency, as soon as they have been drawn, to crystallize, thus fixing their molecular structure and rendering it incapable of a second drawing operation.

For this reason, very many devices known as simultaneous drawing devices, that is to say ones which simultaneously draw in the longitudinal direction and in the transverse direction, have already been proposed. These devices can be classified in two groups, namely, on the one hand, mechanical simultaneous drawing devices and, on the other hand, electronically based simultaneous drawing devices.

In the mechanical devices category a distinction is made between devices of the pantograph type and devices of the variable-pitch screw type.

These devices, which involve fairly complicated mechanical designs, have the twofold disadvantage of being poorly suited to high production rates, precisely because of their mechanical complexity, and of not offering the possibility of adjusting the draw ratio.

In effect, in order to adapt the characteristics of the film or to optimize the drawing specific to each of the products drawn, it is necessary for the transverse, and especially the longitudinal, draw ratios to be adjustable in a simple way. In the mechanical devices mentioned hereinabove, it will be readily appreciated that, although the transverse draw ratio can be adapted relatively easily through the separation of the rails supporting the film-holding grippers, the same is not true of the longitudinal drawing which requires the way in which the grippers progressively diverge from one another in the longitudinal direction during the transverse drawing to be modified.

Devices of the pantograph type are generally completely fixed, that is to say neither the longitudinal draw ratios nor the transverse draw ratios can be adjusted.

Devices of the variable-pitch screw type may possibly be adjusted by replacing the variable-pitch screw which regulates the way in which the grippers progressively diverge.

It will be readily understood that changing screw guides to adjust the draw ratio is a painstaking operation which requires the machine to be shut down, its main components to be opened up, and therefore entails a production down-time of about one day at least.

For the reasons given hereinabove, the mechanical simultaneous drawing devices are being used increasingly less.

In order to remedy the abovementioned disadvantages of the mechanical devices, the electronically based simultaneous drawing devices, such as the one described in European Patent 0 760 739 (BRUCKNER), in which the successive grippers, while remaining guided by rails the separation of which can be varied in order to obtain the desired transverse draw ratio, are no longer connected to one another by any mechanical member of the chain type, have more recently been developed. In this case, the driving of the grippers that transport the film that is to be drawn is provided for each gripper (or for each group of grippers) by an individual motor with which each gripper (or each group of grippers) is equipped, of the linear motor type. In this type of motor, the frequency of the supply current to the linear motors driving each gripper determines the speed of travel of the gripper along the rail, an appropriate variation of the frequencies of two motors that correspond to two successive grippers thereby making it possible to cause the linear speed of travel of each gripper along the rail and therefore the longitudinal draw ratio to evolve progressively.

These devices certainly have the advantage of, theoretically, allowing high production rates, and they also, theoretically, perfectly meet industry's demands to be able easily and continuously throughout production to adjust the longitudinal draw ratio, because all that is actually required is for the basic frequency to be varied in order to increase the production rate and for the frequency between two grippers to be varied in order to vary the relative separation of two grippers and therefore the longitudinal draw ratio.

Electronically based devices such as described hereinabove have effectively been produced in a certain number of cases, chiefly for laboratory machines, and have generally proved satisfactory in this kind of application.

By contrast, their use on production machines intended for industry very soon revealed a certain number of constraints which practically limit their use to very specialist high-cost films.

The first disadvantage results from the very high cost of these devices themselves, which is down to the complexity of the electronic systems used for varying the control frequencies of the motor of each gripper as mentioned hereinabove.

An additional disadvantage soon appeared and results from the fact that the efficiency in terms of energy consumption of the linear motors barely exceeds 0.5, which means that about half the energy needed for driving the grippers, and which very quickly increases as the production rates increase, is converted into heat within each of the linear motors, and that, as a result, these motors have to be cooled inside the oven in which the grippers move, for example by circulating water.

These devices are also extremely sensitive to the contamination of the guide members by the additives that have to be introduced into most packaging films (slip additives, antistatic additives, etc.) and which practically all have the characteristic of undergoing sublimation during the transverse drawing under the combined action of the temperature and the increase in surface area resulting from the drawing, and then of condensing on the first cold component they come across—that is to say, in the context of this type of machine, precisely on the rail which has to be cooled.

It will be readily understood that this contamination of the rails gradually makes it difficult and very soon practically impossible to be certain that the grippers, the synchronism of which is ensured without the presence of any mechanical component, will remain synchronous between the right bank and the left bank of the machine, this absence in synchronism immediately causing the film to wrinkle and tear.

For the reasons mentioned hereinabove, electronically based simultaneous drawing devices with linear motors have seen their use limited either to laboratory use or, when used on an industrial scale, to extremely specialist films such as ultra-thin polyester films. By contrast, the use of such devices may not readily be envisaged for the production of widely used industrial films.

The present invention sets out to eliminate the disadvantages already explained both of the mechanical devices and of the electronically based devices, and thus the objective of the present invention is to provide industry with a simultaneous drawing device that makes it possible to obtain high production rates, as currently demanded by industry, while at the same time allowing stable adjustment of the transverse draw ratio and of the longitudinal draw ratio, during a stoppage or while the films are being produced.

To this end, the subject of the invention is essentially a mechanical device for simultaneously drawing films in the longitudinal direction and in the transverse direction, with the use of successive grippers for holding, transporting and drawing the film, the grippers being supported and guided by rails and driven forward by virtue of an endless chain connecting the grippers together, the endless chain being driven by means of one or more sprockets, the drawing device being characterized in that it comprises, on each side of the film that is to be drawn, an endless chain guided on two rails of variable separation, the endless chain consisting of a succession of links articulated to one another about vertical pins, the grippers being connected to one pin in two or mounted between two links, and protruding on one side of the chain, being guided on one of the two rails, while guide pieces are connected to one pin in two or mounted between two links, between the grippers, and move along the other of the two rails such that according to the separation and/or to the variation in separation of these two rails the successive links of the chain are more or less aligned or, on the other hand, make angles with respect to one another so as to fix and/or modify the distance between the successive grippers.

As a preference, the grippers have bodies articulated about one in two of the vertical hinge pins of the successive links of the chain, whereas the guide pieces are articulated about the other vertical hinge pins of the successive links of the chain which are situated between the previous hinge pins.

In a preferred embodiment, the two rails of variable separation are of the “monorail” type, and the bodies of the grippers on the one hand, and the guide pieces on the other hand, are advantageously equipped with vertical-axis rollers rolling along the two lateral faces of the corresponding rail and with at least one horizontal-axis roller rolling along the top of the corresponding rail. High-speed operation is thus permitted.

Thus, the distance between the two rails, at each point in the path of an endless chain, determines the conduct of that chain and, therefore, the distance between two successive grippers. In particular, a short separation between the two rails places the links of the chain in alignment, which means that the distance between two successive grippers is at a maximum. By contrast, a large separation between the two rails brings the links of the chain into an “zig-zag” configuration, thus with the links placed obliquely, so that the distance between two successive grippers is shorter (possibly going so far as to making the successive grippers contiguous). If the separation between the two rails varies, the configuration of the chain is progressively modified, as this chain is driven forward, the angles formed by the successive links opening up or closing up and the result of this is that the distance between the successive grippers increases or decreases in a way which is forced and perfectly determined by the separation of the two rails.

In particular, if the two rails converge, the angles between the successive links of the chain will gradually open up, and the successive grippers will diverge from one another, thus drawing the film in the longitudinal direction. This arrangement may, in particular, be adopted in divergent portions of the two chains, placed one on each side of the film, so that, in the region considered, the film is drawn simultaneously in the longitudinal direction and in the transverse direction, which here is the desired objective. By contrast, in a preferred arrangement, the two rails are parallel to one another and parallel to the direction in which the film is transported, and have a maximum separation, in a film-preheating region situated upstream of the drawing region, and these two rails are parallel to one another and parallel to the direction in which the film is transported and have a minimum separation in a stabilizing region situated downstream of the drawing region.

However, in this drawing region, the two rails may also diverge, which means that the grippers there are, by contrast, forced to converge, thus making it possible to obtain a “negative” longitudinal draw ratio (or shrinkage ratio), which is required for certain types of film.

Apart from the special structure of the chain, the simultaneous drawing device that is the subject of the invention can use grippers and rails of a type known in the technical field concerned, which means that the device can be produced easily and economically, and that it operates reliably. In particular, because the grippers are connected by the chain, and therefore by a well-known type of mechanical component, the device has a character of reliability and ensures forced synchronism between the grippers, in all the regions of the drawing machine, even in the event of significant contamination. In addition, the grippers can be guided on the rails particularly by rolling, without the need for abundant lubrication which could contaminate the film. The rails used also have the advantage of great flexibility making it possible, without interrupting the continuity of guidance during changes in direction of travel, to obtain divergence angles of as much as 20° or even 25°, and that can be readily adapted, thus allowing drawing that is either progressive or, on the other hand, rapid, that meets the requirements laid down for all the constituent materials of films hitherto known.

Thus, in its entirety, the invention provides a mechanical solution that avoids all the problems currently posed by the simultaneous drawing devices, both the mechanical ones and the electronically based ones.

The invention will be better understood with the aid of the description which follows, with reference to the attached schematic drawing which, by way of example, depicts one embodiment of this simultaneous film drawing device:

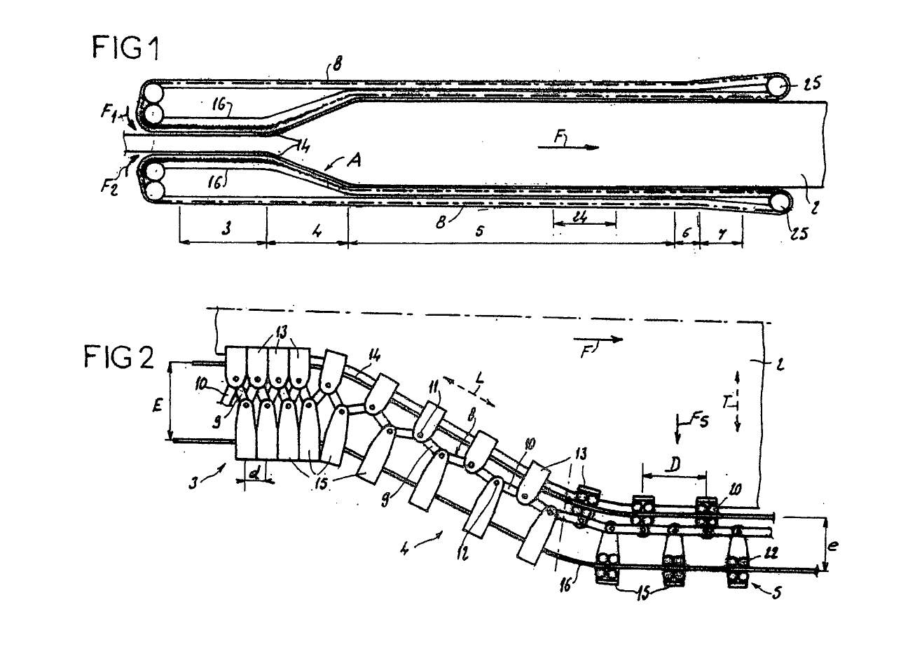

FIG. 1 is a very diagrammatic overall view, in plan, from above, of a simultaneous drawing device according to the present invention;

FIG. 2 is a plan view from above on a larger scale corresponding to region A of FIG. 1;

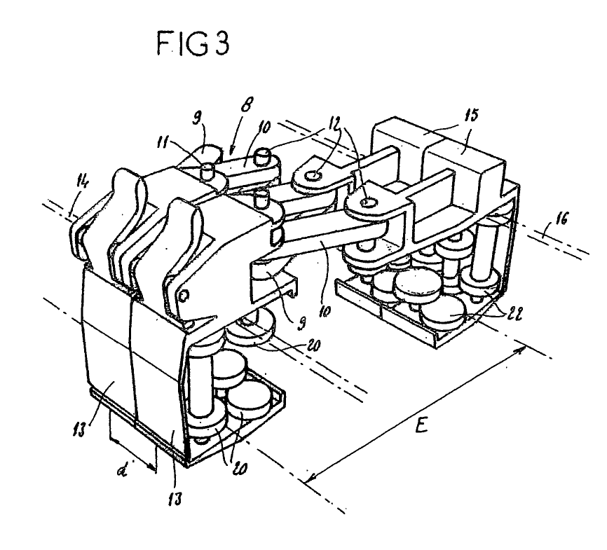

FIG. 3 is a perspective part view of a chain of the device with its grippers and its guide pieces;

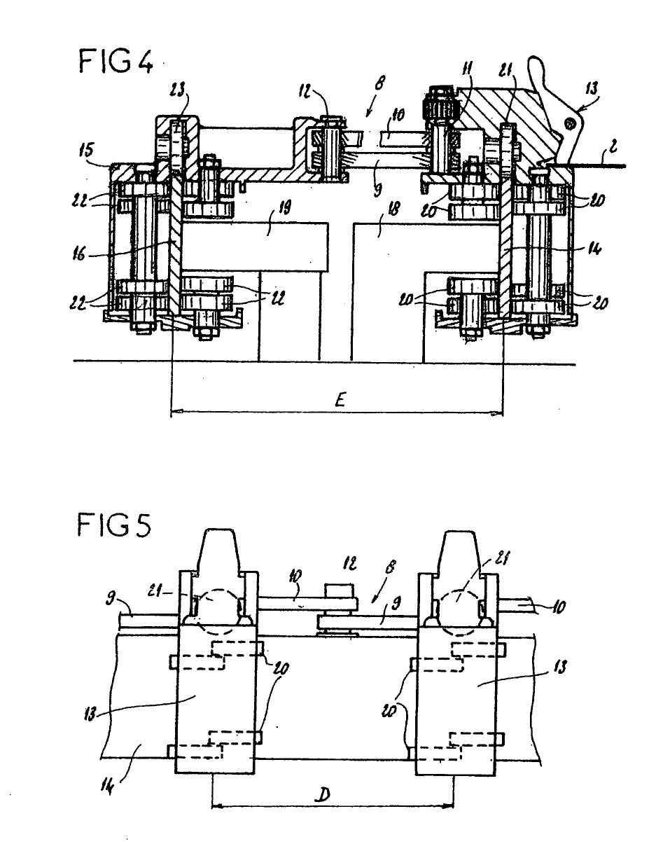

FIG. 4 is a view of the device in cross section;

FIG. 5 is a partial side view, in the direction of the arrow F5 in FIG. 2.

The simultaneous film drawing machine, of which FIG. 1 gives a very schematic overall view, has a temperature-controlled enclosure (not shown in this figure), such an enclosure being well known in the industrial field concerned. This enclosure has a working width which may be as much as 10 meters or more and a length which, according to the desired production rate and the thickness of the film 2, is generally equal to several tens of meters and, in some cases, close to about 100 meters.

Within said enclosure, and from the upstream end downstream, there are a preheating region 3, a drawing region 4, a stabilizing region 5, a neutral region 6 and a cooling region 7. The film 2 is transported in the direction of the arrow F, so that it passes successively through the successive regions 3 to 7, the invention being concerned more particularly with the drawing region 4.

To hold and transport the film 2, the latter is held by its two opposite edges by means of grippers, the structure of which is known and may, in particular, conform to that described in French Patent 9200609/2686041 in the name of the Applicant. These grippers are carried by endless chains 8, arranged symmetrically with respect to the longitudinal axis of the drawing machine, in a horizontal plane and driven by sprockets in the direction of the respective arrows F1 and F2. The active parts of the two endless chains 8 are their respective inner strands, which in particular comprise diverging parts corresponding to the drawing region 4.

The endless chains 8 and their guide means are now described with reference to FIG. 2, which shows detail A of the drawing region 4, and with reference to the subsequent figures.

Each chain 8 consists of a succession of links denoted 9 and 10 alternately, articulated to one another about vertical pins denoted 11 and 12 alternately.

Articulated at every second link, that is to say at each hinge pin 11 between a link 9 and a link 10, is a gripper 13 protruding on one side of the chain 8 and guided on a first rail 14. Articulated also at every second link, but between the grippers 13, that is to say at each hinge pin 12, is a guide piece 15 protruding on the opposite side of the chain 8 and moving along a second rail 16.

The two rails are of the “monorail” type, in the form of a vertical plate, these two rails 14 and 16 being held, at a certain distance from one another (as specified later on), either by T-shaped common supports or by separate supports 18 and 19 (see FIG. 4).

Each gripper 13 has a body which, in the manner of a carriage, bears vertical-axis rollers 20 rolling along the lateral faces of the rail 14, and a horizontal-axis roller 21 rolling along the top of the rail 14.

Similarly, each guide piece 15 forms a carriage, fitted with vertical-axis rollers 22 rolling along the two lateral faces of the rail 16, and a horizontal-axis roller 23 rolling along the top of the rail 16.

On each gripper body 13 and on each guide piece 15, the lateral rollers 20 and 22 here comprise, on each side of the rail 14 or 16, two upper rollers and two lower rollers, it being possible for the two upper rollers to have a slight vertical offset, as do the two lower rollers, so that they can be imbricated, for reasons of compactness.

The two rails 14 and 16 have a variable separation varying between a maximum value E (see FIG. 2, left) and a minimum value e (see FIG. 2, right), it being possible for these two rails 14 and 16 to be parallel to one another or to converge toward or diverge from one another (see FIG. 2, middle). The separation of the two rails 14 and 16 itself determines the distance between two successive grippers 13.

What happens is that, if the two rails 14 and 16 have their maximum separation E, the links 9 and 10 of the chain 8 form a “zig-zag” structure dictated by the maximum separation between the alignment of the grippers 13, on the one hand, and the alignment of the guide pieces 15, on the other. The distance between two successive grippers 13 then takes on its minimum value d.

If the two rails 14 and 16 are parallel and kept at their maximum separation E, the distance between the successive grippers 13 itself too remains constant, and equal to its minimum value d. This is the case, in particular, in the preheating region 3.

Conversely, if the two rails 14 and 16 have their minimum separation e, the links 9 and 10 of the chain 8 are aligned, and this corresponds to a minimum separation between the alignment of the grippers 13, on the one hand, and the alignment of the guide pieces 15, on the other. The distance between two successive grippers 13 then adopts its maximum value D.

If the two rails 14 and 16 are parallel and kept at their minimum separation e, then the distance between the successive grippers 13 itself too remains constant, and equal to its maximum value D. This is the case, in particular, in the stabilizing region 5 while the film 2 is stabilized.

By contrast, it will be readily understood that, when the separation between the two rails 14 and 16 varies, the variable distance between these two rails also causes a variation in the distance between the successive grippers 13. What happens is that the variation in separation between the two rails 14 and 16 causes the angle between the successive links 9 and 10 of the chain 8 to open up or close up, and this forces two successive grippers 13 to converge or to diverge.

In particular, this finds an application in the drawing region 4, where, in the overall divergent path of the two chains 8, the two rails 14 and 16 will progressively converge, thus causing the angle between the successive links 9 and 10 to progressively open up, which opening is accompanied by a progressive divergence of the successive grippers 13, moving from the minimum distance d to the maximum distance D. By thus diverging from one another, the grippers 13 perform longitudinal drawing, denoted L, of the film 2, that is to say perform a drawing in the direction of transportation F of this film 2. At the same time, the divergence of the two chains 8 causes transverse drawing of the same film 2, denoted T, in the same region 4, which means that the desired simultaneous drawing is obtained in this region 4.

It will be noted that, given the ratio between the length of the links 9, 10 of the deployed chain 8 and the length (in projection) of the same links in the folded position, the maximum longitudinal draw ratio is here, in practice, of the order of five to six, which is easily enough for current drawing operations.

At the exit from the drawing region 4, if the two rails 14 and 16 return to being mutually parallel and parallel to the longitudinal direction of the machine, the film 2 will be stabilized in the same way as in the case of sequential drawing. However, in this stabilizing region 5 also, the distance between the two rails 14 and 16 may be varied, allowing the film 2 to stabilize with longitudinal shrinkage or longitudinal extension, for example shrinkage in a partial region marked 24 in FIG. 1.

Mechanical means may be provided for locally modifying the separation of the two rails 14 and 16 and/or their angle of convergence, so as to adjust the longitudinal and transverse draw ratios during production, the rails 14 and 16 being designed to be sufficiently deformable for this to be achieved. This adjustability is an important advantage.

Of course, the device also comprises sprockets 25 for driving and returning the chains 8, and appropriate means for guiding the return strands of these chains 8.

The following would not constitute departures from the scope of the invention as defined in the attached claims:

detail constructional modifications to the chains, particularly to their links;

constructional and/or functional modifications to the grippers and to the guide pieces, it being possible for these grippers and other pieces to be guided along the rails by single or double rolling or sliding;

adaptations to the path of the chains and of their guide rails, according to the characteristics of the installation, to the nature of the film to be drawn, and to the desired longitudinal and transverse draw ratios.

1. A mechanical device for simultaneously drawing plastic films in the longitudinal direction and in the transverse direction, with the use of successive grippers for holding, transporting and drawing the films, the grippers being supported and guided by rails and driven forward by virtue of an endless chain connecting the grippers together, the endless chain being driven by means of one or more sprockets, characterized in that it comprises, on each side of the film that is to be drawn, an endless chain guided on two rails of variable separations the endless chain consisting of a succession of links articulated to one another about vertical pins, the grippers being connected to one pin in two or mounted between two links, and protruding on one side of the chain, being guided on one of the two rails, while guide pieces are connected to one pin in two or mounted between two links, between the grippers, and move along the other of the two rails such that according to the separation and/or to the variation in separation of these two rails the successive links of the chain are more or less aligned or, on the other hand, make angles with respect to one another so as to fix and/or modify the distance between the successive grippers.

2. The simultaneous drawing device as claimed in claim 1, characterized in that the grippers shave bodies articulated about one in two of the vertical hinge pins of the successive links of the chains, whereas the guide pieces are articulated about the other vertical hinge pins of the successive links of the chain which are situated between the previous hinge pins.

3. The simultaneous drawing device as claimed in claim 1, characterized in that the two rails of variable separation are of the “monorail” type, and in that the bodies of the grippers on the one hand, and the guide pieces on the other hand, are equipped with vertical-axis rollers (rolling along the two lateral faces of the corresponding rail and with at least one horizontal-axis roller rolling along the top of the corresponding rail.

4. The simultaneous drawing device as claimed in claim 3, characterized in that, on each gripper body and on each guide piece, the lateral rollers comprise, on each side of the rail, two upper rollers and two lower rollers.

5. The simultaneous drawing device as claimed in claim 4, characterized in that the two upper rollers have a slight vertical offset, as do the two lower rollers, so that they can be imbricated.

6. The simultaneous drawing device as claimed in claim 1, characterized in that, particularly in divergent portions of the two chains, placed one on each side of the films, the two rails converge such that the angles between the successive links of the chain will gradually open up, and the successive grippers will diverge from one another, thus drawing the film in the longitudinal direction and in the transverse directions.

7. The simultaneous drawing device as claimed in claim 6, characterized in that the two rails are parallel to one another and parallel to the direction in which the film His transported, and have a maximum separations, in a film-preheating region situated upstream of the drawing region, and in that these two rails are parallel to one another and parallel to the direction fin which the film is transported and have a minimum separation in a stabilizing region situated downstream of the drawing regions.

8. The simultaneous drawing device as claimed in claim 1, characterized in that mechanical means are provided for locally modifying the separation of the two rails and/or their angle of convergence, so as to adjust the longitudinal and transverse draw ratios during production.
